(19) United States
(12) Patent Application Publication
(10) Pub. No.: US 2019/0283337 A1
(43) Pub. Date: Sep. 19, 2019

(54) MOLD INSERT AND CORRESPONDING COMPOSITE PANEL INSERT

(71) Applicant: Carbon Consultants, LLC dba Zepher, Inc., Bingen, WA (US)

(72) Inventor: Robert Scott Coatney, White Salmon, WA (US)

(73) Assignee: Carbon Consultants, LLC dba Zepher, Inc., Bingen, WA (US)

(21) Appl. No.: 16/355,446

(22) Filed: Mar. 15, 2019

Related U.S. Application Data
(60) Provisional application No. 62/644,795, filed on Mar. 19, 2018.

(51) Int. Cl. B29C 65/56; B29C 70/54; B29C 65/00

(52) U.S. Cl. CPC B29C 65/562; B29C 66/721; B29C 70/54; B29C 70/545

(57) ABSTRACT

Embodiments of the present disclosure may provide a method of forming a molded composite member comprising the following steps, not necessarily in the order recited: selecting a mold insert having an exterior shape conforming to a shape desired to be formed in a first composite member that is pre-impregnated with thermosetting resin; screwing the mold insert into a mold; conforming a surface of the first composite member to the mold insert and mold; curing the resin in the first composite member to render the first composite member rigid and to form a shape in the first composite member corresponding to the shape of the mold insert and the mold; forming a first hole in the first composite member adjacent the shape; forming a second hole in a second member; positioning a washer in the shape in the first composite member, the washer having an exterior conforming with the shape; and extending a linear fastening member through a washer hole, the first hole in the first composite member, and the second hole in the second member.

### CROSS REFERENCE TO RELATED APPLICATIONS

The present application claims priority to U.S. Provisional Patent Application No. 62/644,795, filed Mar. 19, 2018, entitled “MOLD INSERT AND CORRESPONDING COMPOSITE PANEL INSERT,” the entire disclosure of which is incorporated by reference.

### TECHNICAL FIELD

Embodiments herein relate to the field of molded composite parts as well as matching inserts used in finished molded composite parts.

### BACKGROUND

The mechanical fastening of composite panels is more problematic than for other materials. This is especially true when using countersunk fasteners to achieve a smooth outer surface of a fastened composite panel assembly. The dimensions of standard countersunk fasteners are not optimized for use with softer materials such as composites, and even specialized countersunk fasteners still are not ideal.

The traditional method of fastening composite panels with countersunk, flush fasteners is to build up the outer panel thickness with extra layers or plies of composite, and then cut it with a countersinking tool as one might do for a metal part. However, carbon fiber does not act like metal because it is anisotropic; that is, it does not have the same strength and stiffness in all directions.

This presents multiple problems. First, it requires craftsmanship to manually countersink the holes or set a countersinking tool to the correct depth. Second, the outer panel may be so thin that the countersink continues into the inner panel so that the ability of the fastener to clamp the two panels together can be severely compromised. Third, the bearing stresses between the countersunk fastener head and the softer composite panel can be very high. This can cause the fasteners to damage the holes in the outer panel or tear them out completely during high shock loads, such as during a crash of an unmanned aerial vehicle. Fourth, if the fasteners are repeatedly removed and re-installed, they will gradually abrade on the countersunk surface of the outer panel. This surface will eventually need to be repaired or the panel replaced entirely.

Thus, it is a goal of the disclosed embodiments to provide a fastening method for composite panels that enables a reduction in the required composite panel thickness in the vicinity of the fasteners. An additional object is to more effectively distribute stress in the area adjacent the fasteners. A further object is to facilitate expedited repair of countersunk interfaced composite surfaces through the use of a novel fastening system. It would also be desirable to be able to mold in fastener locations, and thereby obviate the need for a drill jig.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a perspective view of an embodiment of the present disclosure showing a mold insert fastened to a mold body;

FIG. 2 is a perspective sectional view of the embodiment of FIG. 1, showing the mold insert fastened to a mold body;

FIG. 3 is a side elevation sectional view corresponding to FIG. 2;

FIG. 4 corresponds to FIG. 3 except that it also shows a molded panel applied over the mold insert, which is fastened to the mold body;

FIG. 5 is a side elevation sectional view of a panel insert mounted to a molded panel with a bolt and nut holding that panel to a second panel;

FIG. 6 is a perspective sectional view corresponding to FIG. 5; and

FIG. 7 a perspective view of one example of the outer surface of a panel insert installed in a molded panel with a fastener installed, corresponding to the underside of the embodiment of FIG. 5.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

The preferred embodiment depicted in the figures includes a circular recess with rounded edges that is molded into a composite panel with a mold insert, and a matched panel insert with a countersunk hole that is placed into the recess to distribute loads between a countersunk fastener and the underlying composite part. Although a round molded recess and insert is the preferred embodiment of this invention, it should not be considered as limiting the scope with regard to other embodiments of the invention.

Also, while the figures focus on the fastening of two composite panels, one to another, it should be understood that most embodiments are also suitable for use in mounting one composite panel to a second panel or member that may be fabricated of a wide variety of materials. The figures also focus on the use of a screw to mount the mold insert to a mold but it should be understood that, instead of the screw, other types of linear engagement members may be used as long as they are capable of being disengaged from the mold when desired.

Embodiments disclosed herein provide a method of forming a molded composite member comprising the following steps, not necessarily in the order recited: selecting a mold insert having an exterior shape conforming to a shape desired to be formed in a first composite member that is pre-impregnated with thermosetting resin; screwing the mold insert into a mold; conforming a surface of the first composite member to the mold insert and mold; curing the resin in the first composite member to render the first composite member rigid and to form a shape in the first composite member corresponding to the shape of the mold insert and the mold; forming a first hole in the first composite member adjacent the shape; forming a second hole in a second member; positioning a washer in the shape in the first composite member, the washer having an exterior conforming with the shape; and extending a linear fastening member through a washer hole, the first hole in the first composite member, and the second hole in the second member.

The method may include the step of applying and tightening an end fastener onto the linear fastening member to securely fasten the first composite member to the second composite member. The step of forming a second hole in a second member may involve forming a second hole in a second composite member. The step of extending a linear fastening member through a washer hole, the first hole in the first composite member, and the second hole in the second member may comprise extending a threaded linear fastening member. The step of extending a threaded linear fastening member may include extending a bolt with a flat head on one end, and further comprising the step of applying and tightening a nut on another end of the bolt.

The step of selecting a mold insert may involve selecting a saucer-shaped mold insert, which may have both convex and concave exterior surfaces. The step of selecting a mold insert may comprise selecting a round member with raised sides. The raises sides may be rounded, may include convex and concave portions or may simply be in the form of a shallow, substantially conical shape.

Other embodiments of the present disclosure provide a method for mounting a curable first composite member to a second member comprising the following steps, not necessarily in the order recited: selecting a mold insert having a centrally-disposed mold insert hole therein and a flat surface; extending a screw through the mold insert hole and applying the screw to a mold such that the flat surface of the mold insert is tight against a surface of the mold; positioning a first side of the first composite member against the surface of the mold to which the mold insert is mounted; spreading the first composite member onto the mold insert and mold such that the shape of the first composite member conforms to the shape of the mold insert and mold; curing the first composite member to form an undercut shape in the first side of the first composite member conforming with the shape of the mold insert and mold; removing the first composite member from the mold insert and mold; forming a first composite member hole in a central portion of the undercut shape, and forming a second member hole in the second member; selecting a washer having a flat side, a rounded side conforming to the undercut shape, and a washer hole; positioning the rounded side of the washer in the first side of the undercut shape in the first composite member; positioning a second side of the first composite member against the second member such that the first composite member hole and the second member hole are aligned; and selecting a linear fastener having a substantially flat top and extending the fastener through the washer hole, the first composite member hole and the second member hole.

The step of selecting a linear fastener may involve selecting a threaded linear fastener. The step of forming a second member hole in the second member may include forming a second member hole in a second composite member, the step of selecting a linear fastener may involve selecting a bolt, and may involve the additional step of screwing a nut onto the bolt to tighten the first composite member against the second composite member.

Embodiments of the present disclosure may also be said to include a method for mounting a curable first composite member to a second composite member comprising the following steps, not necessarily in the order recited: selecting a mold insert having a centrally-disposed mold insert hole therein and a flat surface; extending a linear engagement member through the mold insert hole and applying the linear engagement member to a mold such that the flat surface of the mold insert is tight against a surface of the mold; positioning a first side of the first composite member against the surface of the mold to which the mold insert is mounted; spreading the first composite member onto the mold insert and mold such that the shape of the first composite member conforms to the shape of the mold insert and mold; curing the first composite member to form an undercut shape in the first side of the first composite member conforming with the shape of the mold insert and mold; removing the first composite member from the mold insert and mold; forming a first composite member hole in a central portion of the undercut shape, and forming a second member hole in a second composite member; selecting a washer having a flat side, a rounded side conforming to the undercut shape, and a washer hole; positioning the rounded side of the washer in the first side of the undercut shape in the first composite member; positioning a second side of the first composite member against the second composite member such that the composite member holes are aligned; selecting a linear fastener having a substantially flat top on a first end, and extending the fastener through the washer hole and the composite member holes; and applying an end fastener to a second end of the linear fastener to secure the first and second composite panels to one another.

The step of extending a linear engagement member through the mold insert hole may include extending a screw through the mold insert hole. The step of selecting the linear fastener may involve selecting a bolt and the step of applying an end fastener may include applying a nut to the second end of the bolt.

The preferred embodiment would use a machined metal mold insert and a machined aluminum panel insert. However, the mold insert and the panel insert could be made of any material and from any process, including, but not limited to, CNC machining, conventional machining, injection molding, and 3D printing. The composite panel might be fabricated of a wide variety of materials, including fiberglass, carbon fiber or graphite, Kevlar, Boron, Spectra (sometimes called Dyneema, a UHMW polyethylene in fiber form), and similar materials. Reinforced thermoplastic matrix materials that could be used as the composite panels disclosed herein include polypropylene, polyetherimide, polyamide (nylon or PA), polyether ether ketone (PEEK) and a wide variety of other thermoplastics.

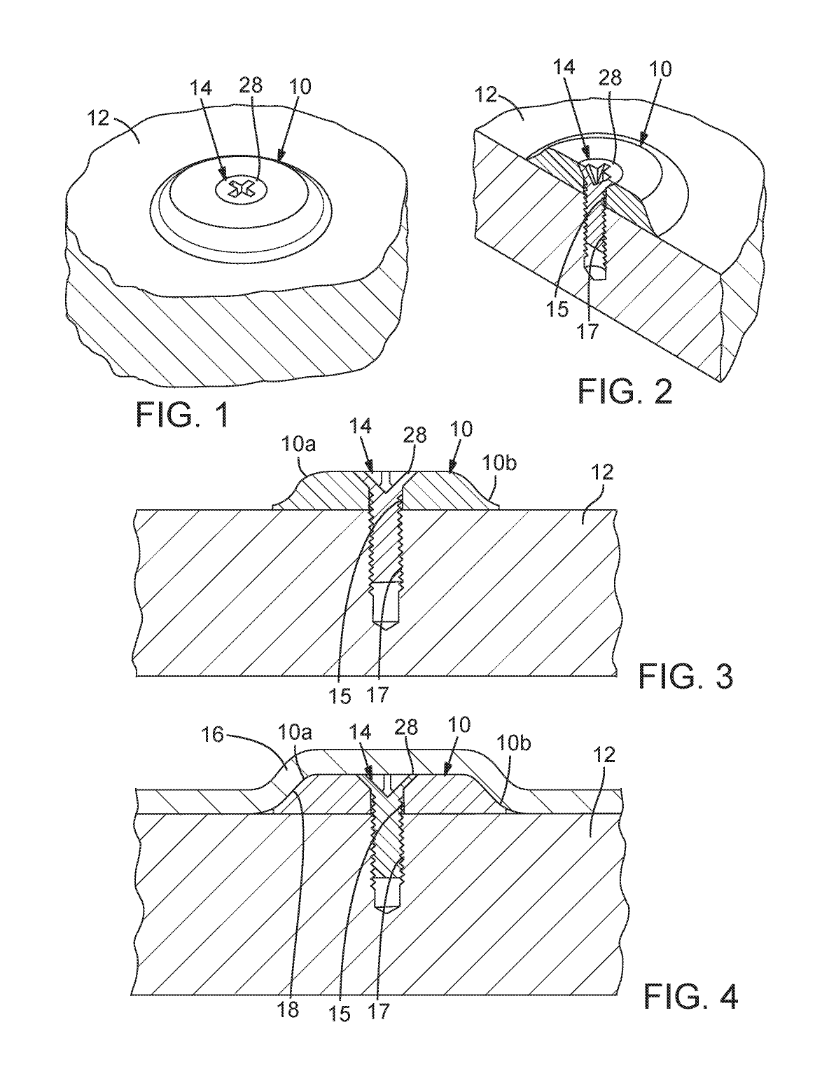

FIG. 1 shows a mold insert 10 attached to a mold 12 with a fastener such as a screw 14. Mold 12 may be formed of tooling foam, such as high-density polyurethane, or of steel, fiberglass or other conventional materials. An enlarged hole 15 with a conical upper end may be formed in mold insert 10. To mount mold insert 10 to mold 12, a hole 17 may be drilled into mold 12, and screw 14 may be extended through holes 15 and 17, to fasten insert 10 to the mold. Hole 17 in mold 12 may be threaded, or screw 14 may simply form the threads as it is screwed into the mold. Screw 14 does not need to be heavy duty, as it is not carrying a load and is only used to locate mold insert 10. Being mounted to mold 12, mold insert 10 is in position to create a negative of itself so the feature in the composite panel to be discussed below does not have to be shaped by hand.

In the depicted embodiment, mold insert 10 is round and substantially saucer-shaped, with convex portions 10a around a top, rounding into convex portions 10b in the area proximal to the mold 12. However, the mold insert may take a wide variety of other shapes depending upon the shape desired to be formed in the composite panels.

As noted above, in the depicted embodiment the mold insert 10 is rounded. A rounded configuration simplifies material placement prior to molding, and facilitates an easier molding of the panel itself. It also reduces local stresses around the panel insert during use. However, any number of other non-rounded shapes might alternatively be used, depending upon the particular application and the materials used.

After mold insert 10 has been mounted in place as shown in FIG. 3, a first composite panel 16 can be applied to the mold insert/mold as shown in FIG. 4. The panel may first be hand-applied to the mold insert/mold, but a system for pressing the panel down onto the mold insert/panel may be used to press the panel in place to the position depicted in FIG. 4, forming a depression 18 in a first surface of first panel 16 that coincides with the exterior configuration of mold insert 10. This system of pressing the first panel down may include a vacuum bag or some other conventional system to make sure the entire panel is pressed against the mold insert/mold.

Other conventional systems for pressing the first composite panel against the mold insert/mold may alternatively be used. For example, simple mechanical compression may be used to make sure the entire panel is pressed against the mold insert/mold. Mechanical compression may be applied with rubber, metal, or air-filled bladder components within a 2-part mold (not shown). If vacuum bag compression is to be used (typically over a 1-part mold), a plastic film is first placed over the composite panel and sealed around the edges. Then, some or all of the air is drawn out with a pump. The resulting differential pressure between the composite material inside the vacuum bag and the local atmospheric pressure will result in a maximum of about 15 pounds per square inch of compression. Typically, only two thirds of a full vacuum is pulled during conventional vacuum bagging processes to avoid boiling off chemicals within the thermoset resin. If more than about 15 per square inch of compression is desired, the vacuum-bagged part may be placed in a pressurized autoclave oven to be cured at higher-than-atmospheric pressures of up to about 60 pounds per square inch.

First composite panel 16 is typically pre-impregnated with thermoset resin so that when the panel/mold insert/mold is heated for a period of 1-2 hours at about 250 degrees Fahrenheit, the thermoset resin in the panel is cured.

One alternative curing method, commonly referred to as “wet layup,” involves thermoset resin being mixed separately and used to manually wet out the composite material before it is then placed against the mold insert/mold. The resins used in this method can typically be cured at room temperature, or cured faster at an elevated temperature if desired.

Another method for conforming the panel to the mold insert/mold and for curing the material in the panel is commonly referred to as “vacuum infusion.” In this embodiment, the composite panel is placed against the mold insert/mold in a dry condition, without any resin. A porous material, to facilitate the flow of resin, would then be placed on top of the composite panel, the panel sealed off (usually with a vacuum bag), and the air would be purged from the layup. A low-viscosity thermoset resin would then be mixed separately and allowed to flow into the dry composite material by way of a small hose, being pushed inside by the ambient atmospheric pressure.

Yet another set up and cure method may be used with thermoplastic panels. When using thermoplastics, the first panel is laid over the mold insert/mold and a sheet of metal or other material conforming to the configuration of the mold insert/mold would be placed on top of the thermoplastic panel. The panel is then heated so the thermoplastic material becomes malleable in order to conform to the shape of the mold insert/mold, and is then cooled. The use of thermoplastic that is softened and then cooled is intended to be within the definition of “curing” as that term is used herein.

Regardless of which method is used, as first composite panel 16 is pressed against the mold insert/mold and the resin therein is cured, mold insert 10 acts as a plug or pattern, forming a depression 18 in the panel, providing the female shape shown in FIG. 4. Mold 12 is shown to be planar in the figures but of course it may, and typically does, have other shapes to which the composite panel would conform.

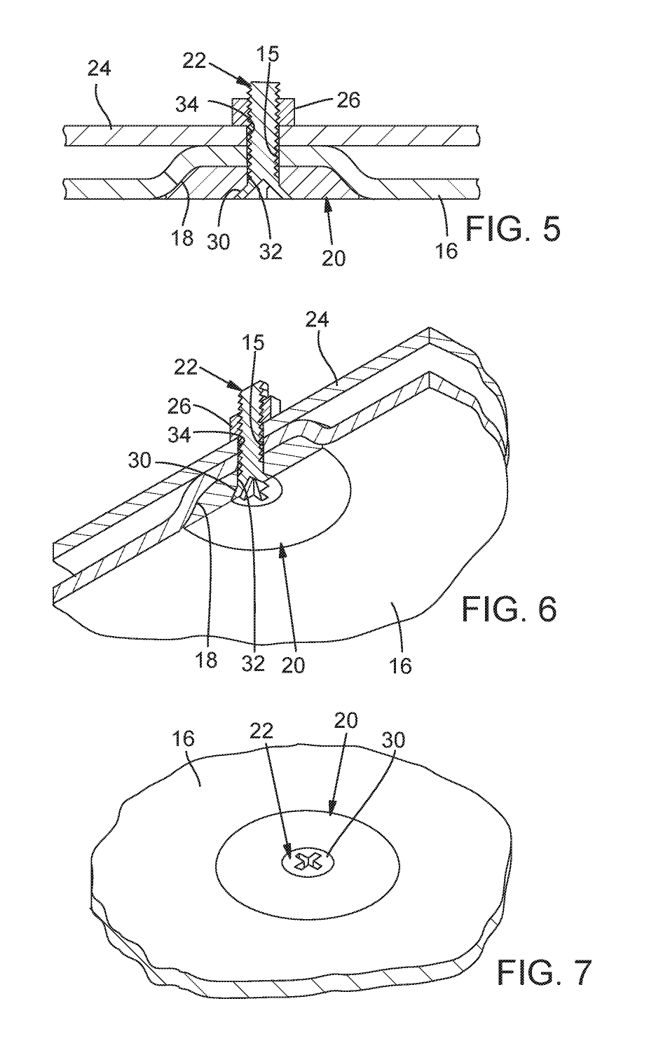

FIGS. 5-7 show how the molded composite panel 16 might be mounted to a second composite panel 24. While the second panel is shown to be the same type of composite material as the first panel, the second panel may be formed of a very different composite material or perhaps formed of some other material altogether. First composite panel 16 is first removed from the mold insert/mold. Then, complementing holes 32 and 34 are drilled in first panel 16 and second panel 24, respectively. Holes 32 and 34 can be slightly larger than the outer diameter of a bolt 22, as the bolt is not threaded into them.

Instead of a bolt 22, other linear fasteners might be utilized. Normally the linear fastener would be threaded but that is not necessarily the case as long as it can fasten the two panels together. In the event a material other than composite is used for second panel 24, it may be that a threaded linear fastener could be screwed directly into the second panel. Or, regardless of the material selected for second panel, a different type of end fastener may be applied to the end of the linear fastener that does not require threads.

FIGS. 5-7 depict the use of a washer 20 that has substantially the same exterior configuration as depression 18 formed in first panel 16 by the mold insert; that is, the washer should have substantially the same exterior configuration as the mold insert. Bolt 22 has been positioned over washer 20, mounting first composite panel 16 to a second composite panel 24 with a nut 26. Bolt 22 may have a flat head that is co-planar with the outer or first surface of first panel 16. Here, nut 26 is a conventional floating nut plate such as sold by Click-Bond, but any conventional nut may be utilized.

FIGS. 5-7 show that a solid mounting is provided that may be entirely flush, as shown on the bottom of FIGS. 5 and 6 and on the top of FIG. 7. This may be a permanent or temporary mounting that is not subject to damage under normal conditions, and does not involve having to apply threads to a panel formed of fiberglass or some other composite.

In the depicted embodiment, screw 14 and bolt 22 are both shown to have conical heads 28 and 30, respectively. However, because mold insert 10 and washer 20 are entirely different parts, the configuration of the two heads do not need to be the same. However, they both typically have flat tops. The screw has a flat top so no indentation is made in the formation of depression 18 in first panel 16. The bolt has a flat top to provide a flush fit, co-planar with an outer or first surface of first panel 16.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method of forming a molded composite member comprising the following steps, not necessarily in the order recited:
selecting a mold insert having an exterior shape conforming to a shape desired to be formed in a first composite member that is pre-impregnated with thermosetting resin;
screwing the mold insert into a mold;
conforming a surface of the first composite member to the mold insert and mold;
curing the resin in the first composite member to render the first composite member rigid and to form a shape in the first composite member corresponding to the shape of the mold insert and the mold;
forming a first hole in the first composite member adjacent the shape;
forming a second hole in a second member;
positioning a washer in the shape in the first composite member, the washer having an exterior conforming with the shape; and
extending a linear fastening member through a washer hole, the first hole in the first composite member, and the second hole in the second member.

2. The method of claim 1, further comprising the step of applying and tightening an end fastener onto the linear fastening member to securely fasten the first composite member to the second composite member.

3. The method of claim 1 wherein the step of forming a second hole in a second member forms a second hole in a second composite member.

4. The method of claim 1 wherein the step of extending a linear fastening member through a washer hole, the first hole in the first composite member, and the second hole in the second member comprises extending a threaded linear fastening member.

5. The method of claim 4 wherein the step of extending a threaded linear fastening member comprises extending a bolt with a flat head on one end, and further comprising the step of applying and tightening a nut on another end of the bolt.

6. The method of claim 1 wherein the step of selecting a mold insert comprises selecting a saucer-shaped mold insert.

7. The method of claim 6 wherein the step of selecting a mold insert comprises selecting a saucer-shaped mold insert that has both convex and concave exterior surfaces.

8. The method of claim 1 wherein the step of selecting a mold insert comprises selecting a round member with raised sides.

9. A method for mounting a curable first composite member to a second member comprising the following steps, not necessarily in the order recited:
selecting a mold insert having a centrally-disposed mold insert hole therein and a flat surface;
extending a screw through the mold insert hole and applying the screw to a mold such that the flat surface of the mold insert is tight against a surface of the mold;
positioning a first side of the first composite member against the surface of the mold to which the mold insert is mounted;
spreading the first composite member onto the mold insert and mold such that the shape of the first composite member conforms to the shape of the mold insert and mold;
curing the first composite member to form an undercut shape in the first side of the first composite member conforming with the shape of the mold insert and mold;
removing the first composite member from the mold insert and mold;
forming a first composite member hole in a central portion of the undercut shape, and forming a second member hole in the second member;
selecting a washer having a flat side, a rounded side conforming to the undercut shape, and a washer hole;
positioning the rounded side of the washer in the first side of the undercut shape in the first composite member;
positioning a second side of the first composite member against the second member such that the first composite member hole and the second member hole are aligned; and
selecting a linear fastener having a substantially flat top and extending the fastener through the washer hole, the first composite member hole and the second member hole.

10. The method of claim 9 wherein the step of selecting a linear fastener comprises selecting a threaded linear fastener.

11. The method of claim 10 wherein the step of forming a second member hole in the second member comprises forming a second member hole in a second composite member, wherein the step of selecting a linear fastener comprises selecting a bolt, and further comprising screwing a nut onto the bolt to tighten the first composite member against the second composite member.

12. A method for mounting a curable first composite member to a second composite member comprising the following steps, not necessarily in the order recited:
selecting a mold insert having a centrally-disposed mold insert hole therein and a flat surface;
extending a linear engagement member through the mold insert hole and applying the linear engagement member to a mold such that the flat surface of the mold insert is tight against a surface of the mold;
positioning a first side of the first composite member against the surface of the mold to which the mold insert is mounted;
spreading the first composite member onto the mold insert and mold such that the shape of the first composite member conforms to the shape of the mold insert and mold;
curing the first composite member to form an undercut shape in the first side of the first composite member conforming with the shape of the mold insert and mold;
removing the first composite member from the mold insert and mold;
forming a first composite member hole in a central portion of the undercut shape, and forming a second member hole in a second composite member;
selecting a washer having a flat side, a rounded side conforming to the undercut shape, and a washer hole;
positioning the rounded side of the washer in the first side of the undercut shape in the first composite member;
positioning a second side of the first composite member against the second composite member such that the composite member holes are aligned;
selecting a linear fastener having a substantially flat top on a first end, and extending the fastener through the washer hole and the composite member holes; and
applying an end fastener to a second end of the linear fastener to secure the first and second composite panels to one another.

13. The method of claim 12 wherein the step of extending a linear engagement member through the mold insert hole comprises extending a screw through the mold insert hole.

14. The method of claim 12 wherein the step of selecting the linear fastener comprises selecting a bolt and the step of applying an end fastener comprises applying a nut to the second end of the bolt.
